(19) United States
(12) Patent Application Publication
(10) Pub. No.: US 2025/0242521 A1
(43) Pub. Date: Jul. 31, 2025

(54) MOLD FOR CONCRETE HOUSE CONSTRUCTION

(71) Applicant: Hebei Feizhuming Aluminum Mould Technology Co., Ltd., Shijiazhuang (CN)

(72) Inventor: Hao Liu, Shijiazhuang (CN)

(21) Appl. No.: 18/612,877

(22) Filed: Mar. 21, 2024

(30) Foreign Application Priority Data
Jan. 29, 2024 (CN) 202420208368.6

(51) Int. Cl. B28B 7/02; B28B 7/00; E04B 1/16

(52) U.S. Cl. CPC B28B 7/02; B28B 7/0014; B28B 7/0035; E04B 1/16

(57) ABSTRACT

The present disclosure provides a mold for concrete house construction, including inner mold plates and outer mold plates driven by an inner mold closing mechanism and an outer mold closing mechanism respectively for mold closing and demolding. The inner mold plates and the outer mold plates are fastened by a mold-closing locking mechanism, and adjacent outer mold plates are locked by an alignment locking mechanism, adjustment assemblies being arranged at a bottom of a cement house mold. The construction quality is improved, and the time for mold closing and demolding is greatly reduced; at the same time, the accuracy of mold closing and demolding of the outer and inner mold plates is improved, and the situation of deflection of the outer mold plate during the mold closing and demolding is avoided, thereby improving the construction efficiency.

### CROSS-REFERENCE TO RELATED APPLICATIONS

This application claims priority of Chinese Patent Application No. 202420208368. 6, filed on Jan. 29, 2024, the entire contents of which are incorporated herein by reference.

### TECHNICAL FIELD

The present disclosure relates to the technical field of cement house construction, and particularly to a mold for concrete house construction.

### BACKGROUND

At present, in the construction of cement houses, the subsequent construction is affected and the construction quality is unqualified due to the long time and incomplete mold closing and demolding. Moreover, in the building construction, after the mold closing is performed on the inner and outer mold plates, the concrete pouring operation is carried out. When the pouring is completed, it is necessary to stand for a period of time and perform the steam curing operation, thereby improving the strength of the wall formed by the concrete pouring. Moreover, when the outer mold plate is driven close to or away from the inner mold plate during the mold closing and demolding, the outer mold plate often deflects, so that the mold closing and demolding cannot be carried out smoothly, and the alignment degree of the inner and outer mold plates after the mold closing cannot reach the expectation, thereby affecting the subsequent pouring operation and the overall strength after the cement house is formed. At the same time, in the building construction, although the mold closing of the inner mold plates and the outer mold plates can achieve a certain compact purpose, gaps between the mold plates at the bottom are easy to appear, thereby causing the bottom leakage when the concrete is poured, affecting the pouring quality. As a result, the subsequent pouring operation and the overall strength of the formed concrete house are affected. Therefore, in view of the above problems, a mold for concrete house construction is provided.

### SUMMARY

An object of the present disclosure is to provide a mold for concrete house construction to solve the problems set forth in the above background.

In order to achieve the above object, the present disclosure provides the following technical solutions.

In an alternative solution of the mold for concrete house construction according to the present disclosure, a mold for concrete house construction includes inner mold plates and outer mold plates driven by an inner mold closing mechanism and an outer mold closing mechanism respectively for mold closing and demolding, the inner mold plates and the outer mold plates being fastened by a mold-closing locking mechanism, and adjacent outer mold plates being locked by an alignment locking mechanism. Adjustment assemblies are arranged at a bottom of the cement house mold.

The adjustment assembly includes a bottom plate, an adjustment sleeve and a pressing plate; an upper portion of the bottom plate is connected to the cement house mold, and the adjustment sleeve is slidably connected to a side of the bottom plate; a top portion of the adjustment sleeve is fixedly connected to the pressing plate, sliding bumps are slidably connected to two sides of the adjustment sleeve, and a side of the sliding bump is fixedly connected to the bottom plate; and a blocking plate is fixedly connected to an interior of the adjustment sleeve, an adjustment main body is spirally connected to an interior of the blocking plate, and an outer side of the adjustment main body is spirally connected to the adjustment sleeve.

The adjustment main body includes an adjustment rod and a mobile plate; an outer side of the adjustment rod is spirally connected to the blocking plate and the adjustment sleeve, and the mobile plate is slidably connected to an interior of the adjustment rod; a side of the mobile plate is fixedly connected to a handle, and a sliding block is slidably connected to an interior of the mobile plate; and a side of the sliding block is fixedly connected to a guide plate, and the other side of the guide plate is fixedly connected to the adjustment rod.

A spring is fixedly connected to a side of the sliding block, and the other side of the spring is fixedly connected to the mobile plate.

In an alternative solution of the mold for concrete house construction according to the present disclosure, the outer mold closing mechanism includes a traveling mechanism driven by a driving mechanism to move the outer mold plates towards or away from the inner mold plates, the traveling mechanism being configured between a base plate and the outer mold plates, and the driving mechanism being configured between the base plate and the traveling mechanism.

In an alternative solution of the mold for concrete house construction according to the present disclosure, the traveling mechanism includes at least two traveling portions, these traveling portions being uniformly mounted between the base and the outer mold plates, and adjacent traveling portions being connected via a connecting rod; and at least one driving mechanisms is arranged, the driving mechanisms being uniformly arranged between the base and the traveling mechanism when a plurality of the driving mechanisms are arranged.

In an alternative solution of the mold for concrete house construction according to the present disclosure, the traveling portion includes a mounting rod movably connected to the base and sliding along the base driven by the driving mechanism; two ends of the connecting rod are detachably connected to two corresponding mounting rods, the mounting rod is connected to the outer mold plate, and a driving end of the driving mechanism is connected to the mounting rod; a fixing rod is fixed at an end of the mounting rod close to the outer mold plate, and the fixing rod is fixedly connected to a lower portion of the outer mold plate; and an inclined strut is fixedly connected to an end of the mounting rod away from the outer mold plate, and the other end of the inclined strut is fixedly connected to an outer surface of the outer mold plate.

In an alternative solution of the mold for concrete house construction according to the present disclosure, guide rails extending along a motion direction of the outer mold plate are mounted on the base, a guide wheel is mounted on the mounting rod, and the guide wheel is assembled on the guide rail and rolls along the guide rail; and racks extending along the motion direction of the outer mold plate are mounted on the base, and gears are rotatably mounted on the mounting rod, the gear being engaged with the rack correspondingly.

In an alternative solution of the mold for concrete house construction according to the present disclosure, the inner mold closing mechanism includes an inclined driving piece mounted on the inner mold plate and on a connecting frame located in a cement house; and several transmission pieces are uniformly connected between the inner mold plate and the connecting frame, two ends of the inclined driving piece are hinged to the inner mold plate and the connecting frame, and two ends of each of the transmission pieces are hinged to the inner mold plate and the connecting frame.

In an alternative solution of the mold for concrete house construction according to the present disclosure, the mold-closing locking mechanism includes a second positioning piece mounted on the outer mold plate and a transverse driving piece mounted on a cross beam mounted on the inner mold plate; an output end of the transverse driving piece is connected to a movable plate, and the second positioning piece extends out of the movable plate via the outer mold plate, the inner mold plate and the cross beam; a first wedge block is mounted on the cross beam, and a second wedge block is mounted on the movable plate at a position corresponding to the first wedge block, an inclined surface of the first wedge block being in contact with that of the second wedge block, and during the demolding and mold closing, the second wedge block slides with the movable plate along the inclined surface of the first wedge block to constitute the locking or unlocking of the second positioning piece with the movable plate.

In an alternative solution of the mold for concrete house construction according to the present disclosure, a guide mounting base is detachably mounted on the cross beam, and the transverse driving piece is mounted on the guide mounting base; a guide fixing base is also detachably mounted on the cross beam, and the second positioning piece extends out of the guide fixing base via the inner mold plate; and the guide mounting base and the guide fixing base are both channel steels, and the movable plate is arranged in a groove of the guide mounting base and the guide fixing base.

In an alternative solution of the mold for concrete house construction according to the present disclosure, the movable plate is disposed with a first insertion hole and a first strip-type slit extending along a sliding direction of the movable plate, the first strip-type slit being communicated with the first insertion hole; a second insertion hole and a second strip-type slit are disposed on the second wedge block, the second insertion hole and the second strip-type slit being respectively arranged corresponding to the first insertion hole and the first strip-type slit; a third insertion hole is disposed on the first wedge block, and a locking portion is formed on the second positioning piece and located at a joint of the first and second wedge blocks, the locking portion being locked at a position where the first and the second strip-type slits overlap; and an inclined angle of inclined surfaces of the first wedge block and the second wedge block is 4.5-5.3° and both of the first wedge block and the second wedge block have a width of 76-84 mm and a height of 158-163 mm.

In an alternative solution of the mold for concrete house construction according to the present disclosure, the alignment locking mechanism includes a vertical driving piece mounted by selecting one outer mold plate, a driving end of the vertical driving piece being connected to a vertical rod; a first positioning piece having two positioning pins is mounted on the vertical rod, positioning holes are disposed on the two mold plates, and each of the positioning pins is inserted into a corresponding positioning hole; a first connecting piece is sleeved on the vertical rod, the first connecting piece is configured with an engaging lug detachably connected to the driving end of the vertical driving piece, and the first positioning piece includes a second connecting piece sleeved on the vertical rod; a mounting base is configured at an end of the second connecting piece, the two positioning pins are configured on the mounting base, connecting plates are mounted on edges of the two mold plates close to each other, and each of the positioning holes is disposed on a corresponding connecting plate; and a limit sleeve is mounted on the vertical rod and close to the first positioning piece, and when the two mold plates are aligned with each other and locked, the limit sleeve is arranged in a gap between two connecting plates.

Compared with the prior art, the present disclosure has the following beneficial effects.

As a result of the above-mentioned structure, the present disclosure has the following technical advantages over the prior art: the mold closing and demolding operations are realized by the inner mold plates and the outer mold plates of the present disclosure by means of the inner mold closing mechanism and the outer mold closing mechanism. When the mold closing is completed, the mold plates are fastened by the mold-closing locking mechanism; when the demolding is required, the locking of the mold-closing locking mechanisms on the inner mold plates and the outer mold plates is released; and the two outer mold plates, when aligned and spliced with each other, are locked by the alignment locking mechanism to avoid the relative dislocation between the outer mold plates. To sum up, in the present disclosure, the construction quality is improved, and the time for mold closing and demolding is greatly reduced; and at the same time, the accuracy of mold closing and demolding of the outer mold plate and the inner mold plate is improved, and the situation where the outer mold plate deflects during the mold closing and demolding is avoided, thereby improving the construction efficiency.

At the same time, the adjustment assemblies are arranged at the bottom of the mold plate, and when in use, the adjustment main bodies are rotated to drive the adjustment sleeves to move, to cause the pressing plates above the adjustment sleeves to be moved, realizing the tight connection between the mold plates, and ensuring the quality of subsequent pouring.

In addition, when the adjustment sleeves are adjusted, the handle can be pulled, and the mobile plates can be driven to rotate by rotating the handle, and the adjustment rods can be driven to rotate; and at this time, adjustments can be performed for fixing the mold plates, the arranged spring can pull the sliding blocks, and the handle can be rotated and reset after use to avoid protruding and affecting the subsequent work.

### BRIEF DESCRIPTION OF THE DRAWINGS

FIG. 1 is a schematic structural diagram according to an example of the present disclosure;

FIG. 2 is a schematic diagram of a partial structure according to an example of the present disclosure;

FIG. 3 is a schematic structural diagram of the locking two outer mold plates according to an example of the present disclosure;

FIG. 4 is a schematic diagram of a partial structure according to an example of the present disclosure;

FIG. 5 is a schematic structural diagram of the connection of a vertical rod and a first positioning piece according to an example of the present disclosure;

FIG. 6 is a schematic structural diagram of an alignment locking mechanism locked according to an example of the present disclosure;

FIG. 7 is a top view of a partial structure of the alignment locking mechanism according to an example of the present disclosure;

FIG. 8 is a schematic structural diagram of the connection of a cross beam, a movable plate, a first wedge block and a second wedge block according to an example of the present disclosure;

FIG. 9 is a schematic structural diagram of the connection of the movable plate and the second wedge block according to an example of the present disclosure;

FIG. 10 is a schematic structural diagram of the connection of the cross beam and the first wedge block according to an example of the present disclosure;

FIG. 11 is a schematic diagram of a partial structure under a demolding state according to an example of the present disclosure;

FIG. 12 is a side view of a partial structure of a mold-closing locking mechanism according to an example of the present disclosure;

FIG. 13 is an enlarged view at A of FIG. 1 according to the present disclosure;

FIG. 14 is a schematic structural diagram of an adjustment assembly according to the present disclosure;

FIG. 15 is a cross-sectional view of the adjustment assembly according to the present disclosure; and

FIG. 16 is a schematic structural diagram of an adjustment main body according to the present disclosure.

Reference numerals and denotations thereof: 1—cement house mold, 2—outer mold plate, 201—connecting plate, 202—fixing base, 3—traveling mechanism, 301—mounting rod, 302—guide wheel, 303—fixing rod, 304—inclined strut, 305—gear, 306—base, 307—rack, 308—guide rail, 309—driving mechanism, 310—connecting rod, 401—vertical driving piece, 402—vertical rod, 403—first positioning piece, 4031—second connecting piece, 4032—mounting base, 4033—positioning pin, 4034—reinforcing rib plate, 4035—limit sleeve, 404—first connecting piece, 5—inner mold plate, 501—cross beam, 502—transverse driving piece, 503—guide mounting base, 504—guide fixing base, 6—movable plate, 601—first insertion hole, 602—first strip-type slit, 603—second wedge block, 6031—second insertion hole, 6032—second strip-type slit, 7—second positioning piece, 701—locking portion, 8—first wedge block, 801—third insertion hole, 9—connecting frame, 10—transmission piece, 11—inclined driving piece, 12—reinforcement piece, 13—adjustment assembly, 1301—bottom plate, 1302—adjustment sleeve, 1303—pressing plate, 1304—sliding bump, 1305—adjustment main body, 13051—adjustment rod, 13052—mobile plate, 13053—handle, 13054—guide plate, 13055—sliding block, 13056—spring, and 1306—blocking plate.

### DETAILED DESCRIPTION

Technical solutions in the examples of the present disclosure will be described clearly and completely in the following with reference to the attached drawings in the examples of the present disclosure. Obviously, all the described examples are only some, rather than all examples of the present disclosure. Based on the examples in the present disclosure, all other examples obtained by those of ordinary skill in the art without creative efforts belong to the scope of protection of the present disclosure.

### Example 1

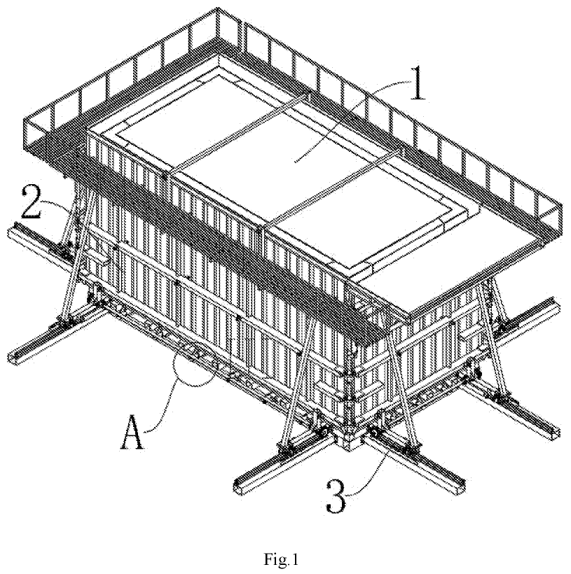

The present disclosure provides a mold for cement house construction, as shown in FIG. 1, including inner mold plates 5 and outer mold plates 2 driven by an inner mold closing mechanism and an outer mold closing mechanism respectively for mold closing and demolding, the inner mold plates 5 and the outer mold plates 2 being fastened by a mold-closing locking mechanism, and adjacent outer mold plates 2 being locked by an alignment locking mechanism. The mold closing and demolding operations are realized by the inner mold plates 5 and the outer mold plates 2 of the present disclosure by means of the inner mold closing mechanism and the outer mold closing mechanism. When the mold closing is completed, the mold plates are fastened by the mold-closing locking mechanism; when the demolding is required, the locking of the mold-closing locking mechanisms on the inner mold plates and the outer mold plates is released; and the two outer mold plates 2, when aligned and spliced with each other, are locked by the alignment locking mechanism to avoid the relative dislocation between the outer mold plates. To sum up, in the present disclosure, the construction quality is improved, and the time for mold closing and demolding is greatly reduced; and at the same time, the accuracy of mold closing and demolding of the outer mold plate 2 and the inner mold plate 5 is improved, and the situation where the outer mold plate 2 deflects during the mold closing and demolding is avoided, thereby improving the construction efficiency.

The adjustment assembly 13 includes a bottom plate 1301, an adjustment sleeve 1302 and a pressing plate 1303; an upper portion of the bottom plate 1301 is connected to a cement house 1, and the adjustment sleeve 1302 is slidably connected to a side of the bottom plate 1301; a top portion of the adjustment sleeve 1302 is fixedly connected to the pressing plate 1303, sliding bumps 1304 are slidably connected to two sides of the adjustment sleeve 1302, and a side of the sliding bump 1304 is fixedly connected to the bottom plate 1301; and a blocking plate 1306 is fixedly connected to an interior of the adjustment sleeve 1302, an adjustment main body 1305 is spirally connected to an interior of the blocking plate 1306, and an outer side of the adjustment main body 1305 is spirally connected to the adjustment sleeve 1302.

The adjustment main body 1305 includes an adjustment rod 13051 and a mobile plate 13052; an outer side of the adjustment rod 13051 is spirally connected to the blocking plate 1306 and the adjustment sleeve 1302, and the mobile plate 13052 is slidably connected to an interior of the adjustment rod 13051; a side of the mobile plate 13052 is fixedly connected to a handle 13053, and a sliding block 13055 is slidably connected to an interior of the mobile plate 13052; and a side of the sliding block 13055 is fixedly connected to a guide plate 13054, and the other side of the guide plate 13054 is fixedly connected to the adjustment rod 13051.

A spring 13056 is fixedly connected to a side of the sliding block 13055, and the other side of the spring 13056 is fixedly connected to the mobile plate 13052.

The adjustment assemblies 13 are arranged at the bottom of the mold plate, and when in use, the adjustment main bodies 1305 are rotated to drive the adjustment sleeves 1302 to move, to cause the pressing plates 1303 above the adjustment sleeves 1302 to be moved, realizing the tight connection between the mold plates, and ensuring the quality of subsequent pouring. In addition, when the adjustment sleeves 1302 are adjusted, the handle 13053 can be pulled, and the mobile plates 13052 can be driven to rotate by rotating the handle 13053, and the adjustment rods 13051 can be driven to rotate; and at this time, adjustments can be performed for fixing the mold plates, the arranged spring 13056 can pull the sliding blocks 13055, and the handle 13053 can be rotated and reset after use to avoid protruding and affecting the subsequent work.

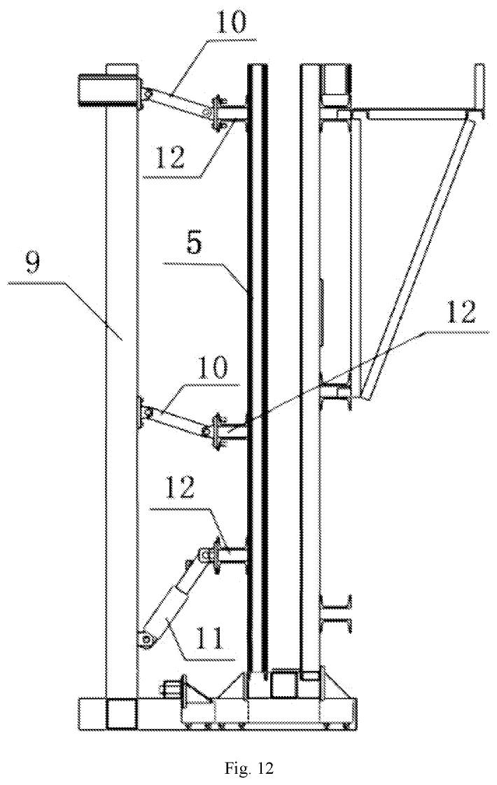

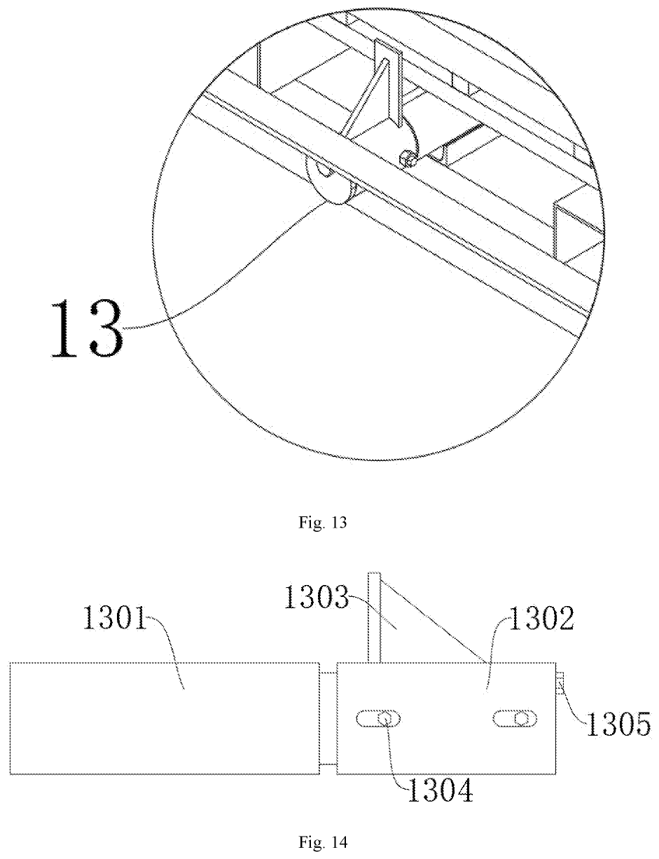

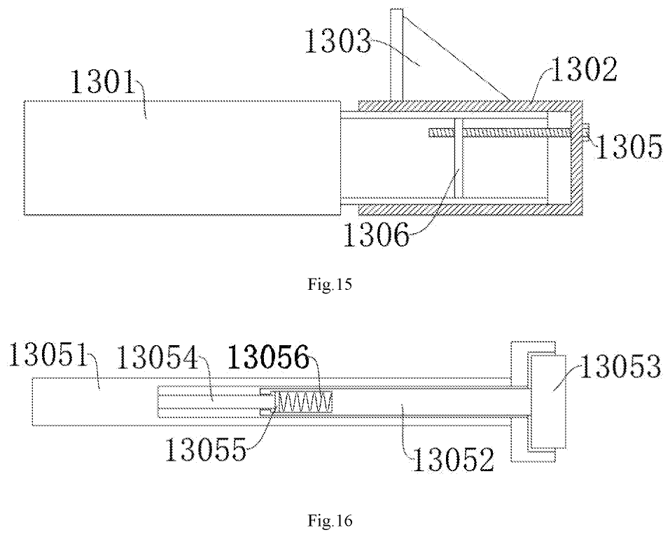

In a preferred example of the present disclosure, as shown in FIG. 12, the inner mold-closing mechanism includes an inclined driving piece 11 and a plurality of transmission pieces 10. The inclined driving piece 11 is arranged on the internal mold plate 5 and on a connecting frame 9 located in a cement house, two ends of the inclined driving piece 11 are hinged to the inner mold plate 5 and the connecting frame 9, the transmission pieces 10 are uniformly connected between the internal mold plate 5 and the connecting frame 9, and two ends of each of the transmission pieces 10 are hinged to the internal mold plate 5 and the connecting frame 9. The working principle and advantages of the present disclosure are that: in the present disclosure, the inner mold plate 5 is driven to move by the inclined driving piece 11, and the two ends of the inclined driving piece 11 are hinged to the inner mold plate 5 and the connecting frame 9, so that the inner mold plate 5 is moved in an arc shape. Since the inner mold plate 5 and the connecting frame 9 are limited by the transmission piece 10, the inner mold plate 5 does not deflect during the arc-shaped motion, so that the mold closing or demolding of the inner mold plate 5 is effectively realized and the time consumption is much lower than the existing mold closing or demolding time. During the mold closing or demolding, since all parts are connected in a hinged way, the phenomenon of jamming or self-locking will not occur in the process of realizing arc motion, and at the same time, there is no need for personnel to directly and manually mold closing or demolding in the process of completing each motion, thereby improving the efficiency of mold closing and demolding and reducing the labor intensity. In order to improve the strength of the inner mold plate 5 and facilitate the mounting, disassembly and maintenance of the inclined driving piece 11 and the transmission pieces 10, as shown in FIG. 12, a plurality of reinforcing pieces 12 are fixedly mounted on the inner mold plate 5 at intervals along a height direction of the inner mold plate 5, each reinforcing piece 12 extends along a width direction of the inner mold plate 5 to two sides of the inner mold plate 5, and the inclined driving piece 11 and each transmission piece 10 are connected to the inner mold plate 5 by a corresponding reinforcement piece 12.

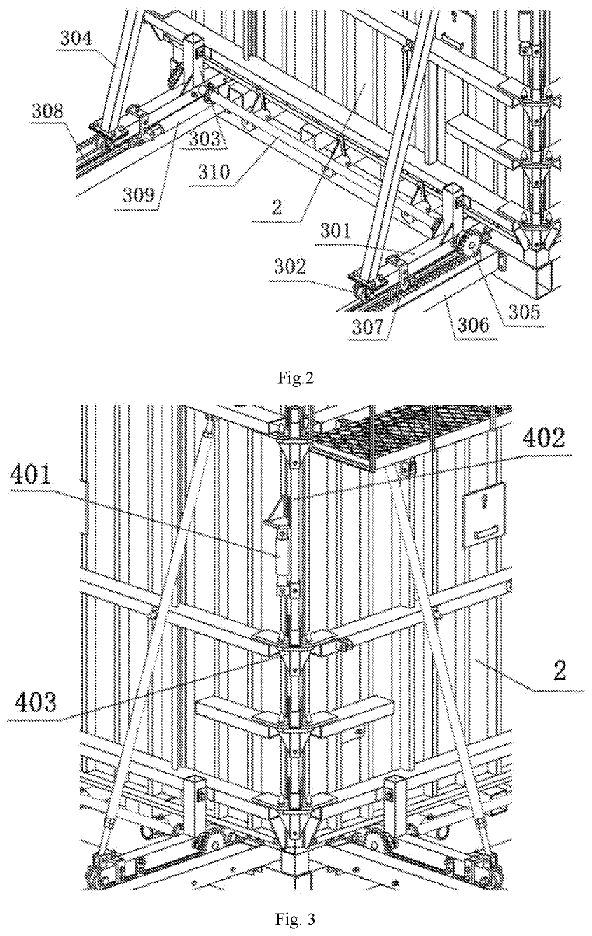

In a preferred example of the present disclosure, as shown in FIGS. 1-2, a demolding device for the outer mold plate is assembled at an outer side of the outer mold plate 2, and the device includes a driving mechanism 309 and a traveling mechanism 3. The traveling mechanism 3 is configured between a base 306 and the outer mold plates 2, and the driving mechanism 309 is configured between the base 306 and the traveling mechanism 3. The driving mechanism 309 drives the traveling mechanism 3 to move, and the traveling mechanism 3 drives the outer mold plates 2 to move towards or away from the inner mold plates. The working principle and advantages of the present disclosure are that: in the present disclosure, during the mold closing and demolding of the cement house mold 1, the traveling mechanism 3 is driven to perform a linear motion by the driving mechanism 309, and since the traveling mechanism 3 is connected to the outer mold plate 2, the outer mold plate 2 performs a linear motion therewith driven by the traveling mechanism 3, thereby realizing that the outer mold plate 2 moves close to or away from the inner mold plate to complete the mold closing and demolding. To sum up, in the present disclosure, the accuracy of mold closing and demolding of the outer mold plate 2 and the inner mold plate is improved, the situation where the outer mold plate 2 deflects during the mold closing and demolding is avoided, and the construction efficiency is improved.

In a preferred example of the present disclosure, in order to further ensure that the outer mold plate 2 maintains the linear motion and prevents the deflection of the outer mold plate 2, as shown in FIG. 2, the traveling mechanism 3 includes at least two traveling portions, these traveling portions being uniformly mounted between the base 306 and the outer mold plates 2, and adjacent traveling portions being connected via a connecting rod 310, to ensure that the traveling portions maintain the synchronous motion after being driven, and ensuring that the motion of each part of the outer mold plate 2 is consistent to avoid the deflection of the outer mold plate 2. At least one driving mechanism 309 is arranged, the driving mechanisms 309 being uniformly arranged between the base 306 and the traveling mechanism 3 when a plurality of the driving mechanisms 309 are arranged, so that the plurality of traveling portions are synchronously driven by the driving mechanisms 309 to smoothly move in a straight line. The driving mechanism 309 of the example includes a hydraulic cylinder, an air cylinder or an electric cylinder.

In a preferred example of the present disclosure, as shown in FIG. 2, the traveling portion includes a mounting rod 301 movably connected to the base 306 and the connecting rod 310. The mounting rod 301 is connected to a driving end of the driving mechanism 309 and slides on the base 306 driven by the driving mechanism 309, two ends of the connecting rod 310 are detachably connected to two corresponding mounting rods 301, and the mounting rod 301 is connected to the outer mold plate 2. The mounting rod 301 slides on the base 306 driven by the driving mechanism 309, and the adjacent traveling portions are connected by the connecting rods 310 so that the traveling portions move synchronously.

In a preferred example of the present disclosure, the mounting rod 301 is connected to the outer mold plate 2 in a manner shown in FIG. 2. Specifically, a fixing rod 303 is fixed at an end of the mounting rod 301 close to the outer mold plate 2, and the fixing rod 303 is fixedly connected to a lower portion of the outer mold plate 2. Moreover, in the example, in order to make the lower part and the upper part of the outer mold plate 2 synchronously move during the movement of the outer mold plate 2, the adopted measures are that an inclined strut 304 is fixedly connected to an end of the mounting rod 301 away from the outer mold plate 2, and the other end of the inclined strut 304 is fixedly connected to an outer surface of the outer mold plate 2 and is located at the upper position of the outer mold plate 2.

In a preferred example of the present disclosure, in order to further ensure that the outer mold plate 2 maintains moving in a straight line, a guiding instrument is used. Specifically, guide rails 308 extending along a motion direction of the outer mold plate 2 are mounted on the base 306, a guide wheel 302 is mounted on the mounting rod 301, and the guide wheel 302 is assembled on the guide rail 308 and rolls along the guide rail 308. Moreover, racks 307 extending along the motion direction of the outer mold plate 2 are mounted on the base 306, and gears 305 are rotatably mounted on the mounting rod 301, the gear 305 being engaged with the rack 307 correspondingly.

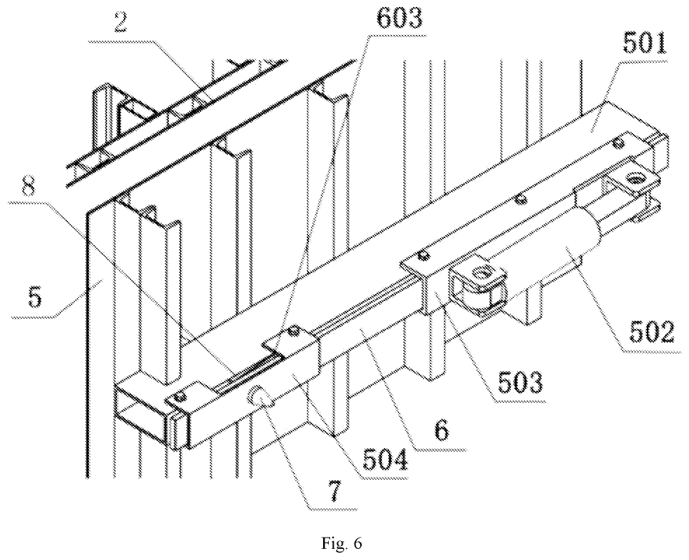

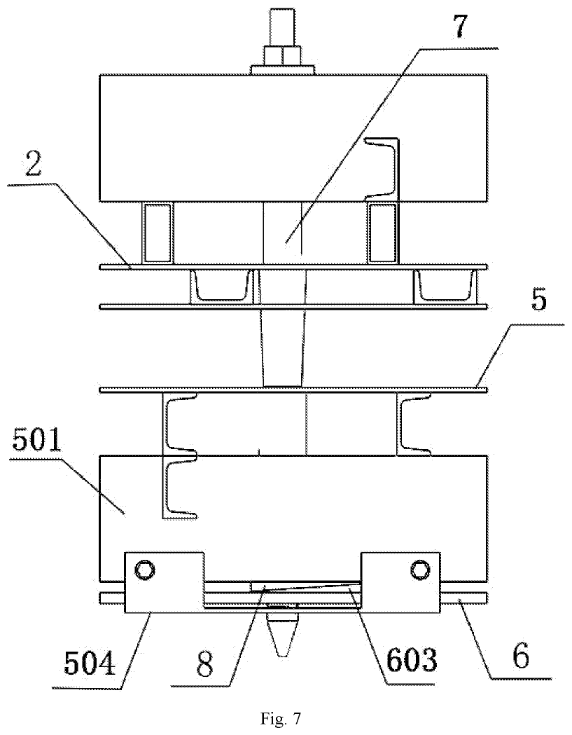

In a preferred example of the present disclosure, as shown in FIGS. 6-7, the mold-closing locking mechanism includes a transverse driving piece 502, a movable plate 6, a first wedge block 8 and a second wedge block 603. A second positioning piece 7 is mounted on the outer mold plate 2, a cross beam 501 is mounted on the inner mold plate 5, the transverse driving piece 502 is a hydraulic cylinder, and the hydraulic cylinder is mounted on the cross beam 501. An output end of the hydraulic cylinder is fixedly connected to the movable plate 6, the second positioning piece 7 extends out of the movable plate 6 via the outer mold plate 2, the inner mold plate 5 and the cross beam 501, and the first wedge block 8 is mounted on the cross beam 501. A second wedge block 603 is mounted on the movable plate 6, and the second wedge block 603 is arranged with the first wedge block 8 correspondingly, an inclined surface of the first wedge block 8 being in contact with that of the second wedge block 603. Moreover, during the mold closing and demolding, the second wedge block 603 slides along the inclined surface of the first wedge block 8 along with the movable plate 6, thereby realizing the locking or unlocking of the second positioning piece 7 with the movable plate 6. The working principle and advantages of the present disclosure are that: in the present disclosure, the first wedge block 8 and the second wedge block 603 are arranged. The first wedge block 8 is fixedly connected to the inner mold plate 5 by being mounted on the cross beam 501. The second wedge block 603 is connected to the movable plate 6, and when the mold closing is performed, the second wedge block 603 moves with the movable plate 6, thereby making the second wedge block 603 slide relative to the first wedge block 8, and preventing the movable plate 6 from being misaligned downwards. After the mold closing is completed, the second positioning piece 7 locks the movable plate 6 and the cross beam 501, and at this time, the first wedge block 8 and the second wedge block 603 support each other, avoiding the problem that the movable plate 6 and the cross beam 501 are loose. During the demolding, the second wedge block 603 slides along the inclined surface of the first wedge block 8 along with the movable plate 6, effectively preventing the problem of jamming. To sum up, in the present disclosure, the problem that the second positioning piece 7 and the plate-shaped structure are misaligned in a locked state is solved, and at the same time, the demolding operation is convenient, and the problem of the jamming of the second positioning piece 7 and the plate-shaped structure is avoided.

In a preferred example of the present disclosure, in order to facilitate the mounting of the transverse driving piece 502, as shown in FIG. 6, a guide mounting base 503 is detachably mounted on the cross beam 501, and the transverse driving piece 502 is mounted on the guide mounting base 503. A guide fixing base 504 is also detachably mounted on the cross beam 501, and the second positioning piece 7 extends out of the guide fixing base 504 via the inner mold plate 5. In order to prevent the movable plate 6 from being misaligned, the guide mounting base 503 and the guide fixing base 504 are channel steels, and the movable plate 6 is arranged in a groove of the guide mounting base 503 and the guide fixing base 504, and is driven to slide along a groove guiding direction of the channel steels.

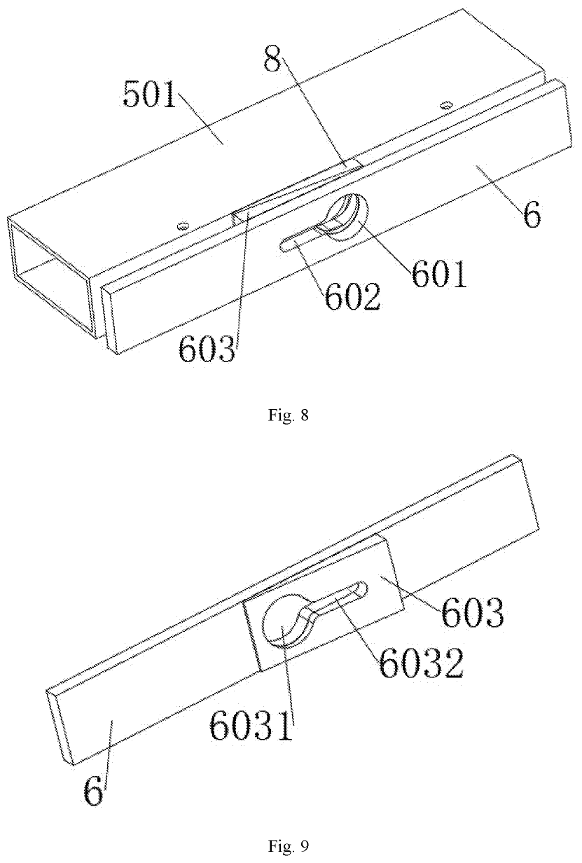

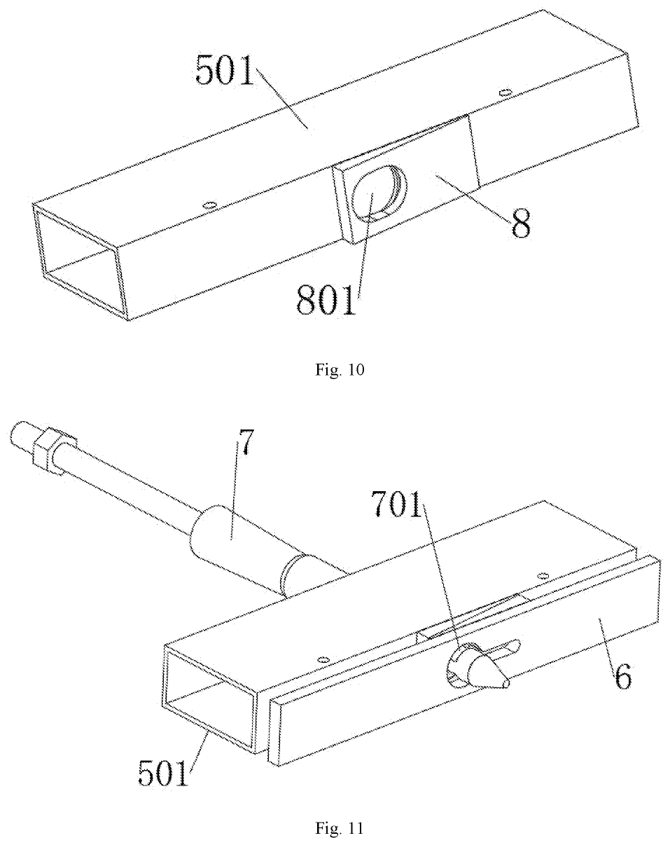

In a preferred example of the present disclosure, as shown in FIGS. 8-10, the movable plate 6 is disposed with a first insertion hole 601 and a first strip-type slit 602 extending along a sliding direction of the movable plate 6, the first strip-type slit 602 being communicated with the first insertion hole 601. In the example, a second insertion hole 6031 and a second strip-type slit 6032 are disposed on the second wedge block 603, the second insertion hole 6031 and the second strip-type slit 6032 being respectively arranged corresponding to the first insertion hole 601 and the first strip-type slit 602; and a third insertion hole 801 is disposed on the first wedge block 8, and a locking portion 701 is formed on the second positioning piece 7 and located at a joint of the first wedge block 8 and the second wedge block 603. In the locking process, the movable plate 6 slides, and the positions of the first insertion hole 601 and the locking portion 701 are far away from each other, so that the locking portion 701 slides into a position where the first strip-type slit 602 and the second strip-type slit 6032 overlap until it is in place, and finally the locking of the inner mold plate 5 and the outer mold plate 2 is realized. In the example, an inclined angle of inclined surfaces of the first wedge block 8 and the second wedge block 603 is 4.5-5.3°, and both of the first wedge block 8 and the second wedge block 603 have a width of 76-84 mm and a height of 158-163 mm.

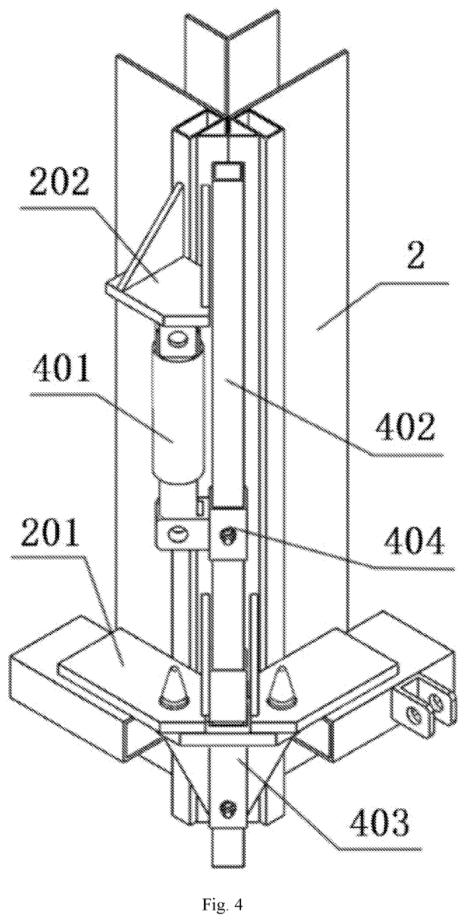

In a preferred example of the present disclosure, as shown in FIGS. 3-4, an alignment locking mechanism is configured at a splicing end of two adjacent outer mold plates 2. The alignment locking mechanism includes a vertical driving piece 401, the vertical driving piece 401 being a hydraulic cylinder or an air cylinder, preferably a hydraulic cylinder. An end of the vertical driving piece 401 is fixedly mounted with a fixing base 202, and the fixing base 202 is mounted on one of the two outer mold plates 2; the driving end of the vertical driving piece 401 is connected to a vertical rod 402, and the vertical rod 402 is arranged at a position between adjacent edges of the two outer mold plates 2; and a first positioning piece 403 is mounted on the vertical rod 402, the first positioning piece 403 has two positioning pins 4033, positioning holes are disposed on the two outer mold plates 2, and each positioning pin 4033 is inserted into a corresponding positioning hole along with the motion of the vertical rod 402. The working principle and advantages of the present disclosure are that: when the two outer mold plates 2 are aligned and spliced with each other, the vertical rod 402 moves vertically by driving the vertical driving piece 401 of the present disclosure, and the vertical rod 402 drives the first positioning piece 403 to approach the positioning holes on the outer mold plates 2 until the two positioning pins 4033 are inserted into the positioning holes on the two outer mold plates 2, thereby locking the two outer mold plates 2. In the present disclosure, the two limiting pins are connected to two outer mold plates 2 to realize the position locking of the two outer mold plates 2, and the first positioning piece 403 locks the two outer mold plates 2. To sum up, the present disclosure has the improved efficiency of mold closing or demolding, strong stability, and convenient operation.

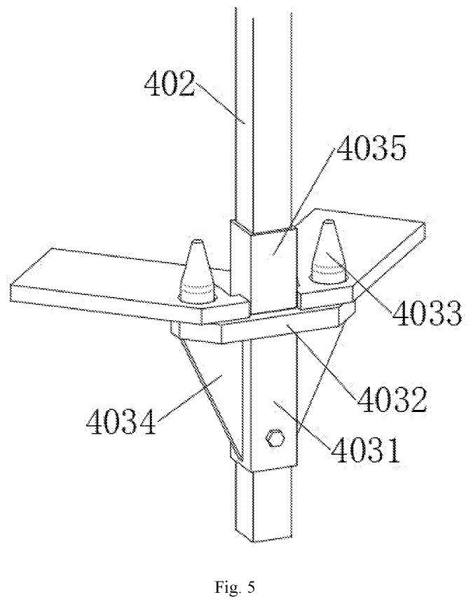

In a preferred example of the present disclosure, as shown in FIG. 4, a first connecting piece 404 is sleeved on the vertical rod 402, the first connecting piece 404 being configured with an engaging lug detachably connected to the driving end of the vertical driving piece 401. In the example, the first positioning piece 403 includes a second connecting piece 4031, as shown in FIG. 5, the second connecting piece 4031 is sleeved on the vertical rod 402, a mounting base 4032 is configured at an end of the second connecting piece 4031, and the two positioning pins 4033 are configured on the mounting base 4032. In order to improve the connection strength of the mounting base 4032 and the second connecting piece 4031, a plurality of reinforcing rib plates 4034 are configured between the mounting base 4032 and the second connecting piece 4031. In the example, connecting plates 201 are mounted on edges of the two outer mold plates 2 close to each other, and each of the positioning holes is disposed on a corresponding connecting plate 201. In the example, a limit sleeve 4035 is mounted on the vertical rod 402 and close to the first positioning piece 403, and when the two outer mold plates 2 are aligned with each other and locked, the limit sleeve 4035 is located in a gap between two connecting plates 201. In the example, in order to avoid the rotation after the first connecting piece 404 and the second connecting piece 4031 are connected to the vertical rod 402, a cross section of the vertical rod 402 is a polygonal structure.

In a preferred example of the present disclosure, in order to improve the locking degree of the two outer mold plates 2 and avoid the occurrence of a local gap at the joint of the outer mold plates 2, as shown in FIG. 3, a plurality of the first positioning pieces 403 are arranged, these first positioning pieces 403 being arranged at intervals along a length direction of the vertical rod 402; and a plurality of the positioning holes are arranged, these positioning holes being arranged in alignment with the positioning pins 4033 on the corresponding first positioning pieces 403.

Finally, it is to be noted that: the above is only the preferred example of the present disclosure, and is not used to limit the present disclosure. Although the present disclosure has been described in detail with reference to the foregoing examples, for those skilled in the art, it is still possible to modify the technical solution described in the foregoing examples or to equally replace some technical features. Any modifications, equivalent substitutions and improvements made within the spirit and principle of the present disclosure are to be included in the scope of protection of the claims of the present disclosure.

It is to be noted that in this specification, relational terms such as “first” and “second” are only used to distinguish one entity or operation from another entity or operation, and do not necessarily require or imply that there is any such an actual relationship or order between these entities or operations. Moreover, the terms “including”, “containing” or any other variations are intended to cover non-exclusive inclusion, so that a process, method, article or equipment including a series of elements includes not only those elements, but also other elements not explicitly listed or elements inherent to such a process, method, article or equipment.

While examples of the present disclosure have been shown and described, it will be understood by those skilled in the art that various changes, modifications, substitutions and alterations may be made herein without departing from the principles and spirit of the present disclosure, the scope of which is defined by the appended claims and equivalents thereof.

1. A mold for cement house construction, comprising inner mold plates and outer mold plates driven by an inner mold closing mechanism and an outer mold closing mechanism respectively for mold closing and demolding, the inner mold plates and the outer mold plates being fastened by a mold-closing locking mechanism, and adjacent outer mold plates being locked by an alignment locking mechanism, wherein adjustment assemblies are arranged at a bottom of a cement house mold;
the adjustment assembly comprises a bottom plate, an adjustment sleeve and a pressing plate; an upper portion of the bottom plate is connected to the cement house mold, and the adjustment sleeve is slidably connected to a side of the bottom plate; a top portion of the adjustment sleeve is fixedly connected to the pressing plate, sliding bumps are slidably connected to two sides of the adjustment sleeve, and a side of the sliding bump is fixedly connected to the bottom plate; and a blocking plate is fixedly connected to an interior of the adjustment sleeve, an adjustment main body is spirally connected to an interior of the blocking plate, and an outer side of the adjustment main body is spirally connected to the adjustment sleeve;
the adjustment main body comprises an adjustment rod and a mobile plate; an outer side of the adjustment rod is spirally connected to the blocking plate and the adjustment sleeve, and the mobile plate is slidably connected to an interior of the adjustment rod; a side of the mobile plate is fixedly connected to a handle, and a sliding block is slidably connected to an interior of the mobile plate; and a side of the sliding block is fixedly connected to a guide plate, and the other side of the guide plate is fixedly connected to the adjustment rod; and
a spring is fixedly connected to a side of the sliding block, and the other side of the spring is fixedly connected to the mobile plate.

2. The mold for cement house construction according to claim 1, wherein the outer mold closing mechanism comprises a traveling mechanism driven by a driving mechanism to move the outer mold plates towards or away from the inner mold plates, the traveling mechanism being configured between a base plate and the outer mold plates, and the driving mechanism being configured between the base plate and the traveling mechanism.

3. The mold for cement house construction according to claim 2, wherein the traveling mechanism comprises at least two traveling portions, these traveling portions being uniformly mounted between the base and the outer mold plates, and adjacent traveling portions being connected via a connecting rod; and at least one driving mechanisms is arranged, the driving mechanisms being uniformly arranged between the base and the traveling mechanism when a plurality of the driving mechanisms are arranged.

4. The mold for cement house construction according to claim 3, wherein the traveling portion comprises a mounting rod movably connected to the base and sliding along the base driven by the driving mechanism; two ends of the connecting rod are detachably connected to two corresponding mounting rods, the mounting rod is connected to the outer mold plate, and a driving end of the driving mechanism is connected to the mounting rod; a fixing rod is fixed at an end of the mounting rod close to the outer mold plate, and the fixing rod is fixedly connected to a lower portion of the outer mold plate; and an inclined strut is fixedly connected to an end of the mounting rod away from the outer mold plate, and the other end of the inclined strut is fixedly connected to an outer surface of the outer mold plate.

5. The mold for cement house construction according to claim 4, wherein guide rails extending along a motion direction of the outer mold plate are mounted on the base, a guide wheel is mounted on the mounting rod, and the guide wheel is assembled on the guide rail and rolls along the guide rail; and racks extending along the motion direction of the outer mold plate are mounted on the base, and gears are rotatably mounted on the mounting rod, the gear being engaged with the rack correspondingly.

6. The mold for cement house construction according to claim 1, wherein the inner mold closing mechanism comprises an inclined driving piece mounted on the inner mold plate and on a connecting frame located in a cement house; and several transmission pieces are uniformly connected between the inner mold plate and the connecting frame, two ends of the inclined driving piece are hinged to the inner mold plate and the connecting frame, and two ends of each of the transmission pieces are hinged to the inner mold plate and the connecting frame.

7. The mold for cement house construction according to claim 1, wherein the mold-closing locking mechanism comprises a second positioning piece mounted on the outer mold plate and a transverse driving piece mounted on a cross beam mounted on the inner mold plate; an output end of the transverse driving piece is connected to a movable plate, and the second positioning piece extends out of the movable plate via the outer mold plate, the inner mold plate and the cross beam; a first wedge block is mounted on the cross beam, and a second wedge block is mounted on the movable plate at a position corresponding to the first wedge block, an inclined surface of the first wedge block being in contact with that of the second wedge block, and during the demolding and mold closing, the second wedge block slides with the movable plate along the inclined surface of the first wedge block to constitute the locking or unlocking of the second positioning piece with the movable plate.

8. The mold for cement house construction according to claim 7, wherein a guide mounting base is detachably mounted on the cross beam, and the transverse driving piece is mounted on the guide mounting base; a guide fixing base is also detachably mounted on the cross beam, and the second positioning piece extends out of the guide fixing base via the inner mold plate; and the guide mounting base and the guide fixing base are both channel steels, and the movable plate is arranged in a groove of the guide mounting base and the guide fixing base.

9. The mold for cement house construction according to claim 7, wherein the movable plate is disposed with a first insertion hole and a first strip-type slit extending along a sliding direction of the movable plate, the first strip-type slit being communicated with the first insertion hole; a second insertion hole and a second strip-type slit are disposed on the second wedge block, the second insertion hole and the second strip-type slit being respectively arranged corresponding to the first insertion hole and the first strip-type slit; a third insertion hole is disposed on the first wedge block, and a locking portion is formed on the second positioning piece and located at a joint of the first and second wedge blocks, the locking portion being locked at a position where the first and the second strip-type slits overlap; and an inclined angle of inclined surfaces of the first wedge block and the second wedge block is 4.5-5.3°, and both of the first wedge block and the second wedge block have a width of 76-84 mm and a height of 158-163 mm.

10. The mold for cement house construction according to claim 1, wherein the alignment locking mechanism comprises a vertical driving piece mounted by selecting one outer mold plate, a driving end of the vertical driving piece being connected to a vertical rod; a first positioning piece having two positioning pins is mounted on the vertical rod, positioning holes are disposed on the two mold plates, and each of the positioning pins is inserted into a corresponding positioning hole; a first connecting piece is sleeved on the vertical rod, the first connecting piece is configured with an engaging lug detachably connected to the driving end of the vertical driving piece, and the first positioning piece comprises a second connecting piece sleeved on the vertical rod; a mounting base is configured at an end of the second connecting piece, the two positioning pins are configured on the mounting base, connecting plates are mounted on edges of the two mold plates close to each other, and each of the positioning holes is disposed on a corresponding connecting plate; and a limit sleeve is mounted on the vertical rod and close to the first positioning piece, and when the two mold plates are aligned with each other and locked, the limit sleeve is arranged in a gap between two connecting plates.
